(19) United States
(12) Patent Application Publication
(10) Pub. No.: US 2006/0262030 A1
(43) Pub. Date: Nov. 23, 2006

(54) Layer-built antenna

(76) Inventors: Seok Bae, Seoul (KR); Jae Suk Sung, Yongin (KR); Mano Yasuhiko, Suwon (KR)

Correspondence Address: LOWE HAUPTMAN BERNER, LLP, 1700 DIAGONAL ROAD, SUITE 300, ALEXANDRIA, VA, 22314, US

(21) Appl. No.: 11/418,206

(22) Filed: May 5, 2006

(30) Foreign Application Priority Data
May 6, 2005 (KR) 10-2005-38023

(51) Int. Cl. H01Q 1/36

(52) U.S. Cl. 343/895; 343/700 MS

(57) ABSTRACT

The present invention relates to a layer-built antenna which adopts a substrate made of a composite of magnetic material and polymer resin or a high magnetic permeability layer installed adjacent to a conductive antenna pattern in order to shorten the resonant length, by which the antenna can be reduced in size. The layer-built antenna has antenna structures each including a magnetic dielectric substrate having predetermined relative magnetic permeability and relative dielectric constant and a conductive antenna pattern formed on the magnetic dielectric substrate. A feeding part is formed on the magnetic dielectric substrates of the antenna structures and electrically connected with the conductive antenna patterns of the antenna structures. The antenna structures are stacked one on another, and the conductive antenna patterns on upper and lower ones of the stacked antenna structures are electrically connected together.

### RELATED APPLICATION

The present application is based on and claims priority from Korean Application Number 10-2005-0038023, filed May 6, 2005, the disclosure of which is hereby incorporated by reference herein in its entirety.

### BACKGROUND OF THE INVENTION

1. Field of the Invention

The present invention relates to a layer-built antenna, and more particularly to a layer-built antenna which adopts a substrate made of a composite of magnetic material and polymer resin or a high magnetic permeability layer installed adjacent to a conductive antenna pattern in order to shorten the resonant length, by which the antenna can be reduced in size.

2. Description of the Related Art

Currently, mobile communication terminals have demands for various service functions as well as size and weight reduction. In order to meet such demands, a mobile communication terminal tends to adopt internal circuits and components which are more compact-sized as well as multi-functional. Such demands are the same for an antenna that is an important component of the mobile communication terminal. In particular, the Digital Multimedia Broadcasting (DMB) expected to begin commercial service from 2005 is classified into satellite DMB using 2630 MHz to 2655 MHz bandwidth and terrestrial DMB using 180 MHz to 210 MHz bandwidth. In the terrestrial DMB using a relatively low frequency bandwidth, size reduction of an antenna becomes an important technical requirement.

Generally, typical antennas have adopted a conductor the resonant length of which is about ½ or ¼ of free space wavelength. Representative examples of the antennas include a metal rod antenna or an antenna with a conductor coated with an insulating material. Such an antenna has a resonant length of ½ or ¼ of free space wavelength, which requires antenna length of about tens of centimeters or several meters in a relatively low VHF bandwidth.

In order to shorten or reduce the antenna length, dielectric materials of a predetermined dielectric constant has been used for antennas. For example, where an antenna adopts a dielectric substance having a relative dielectric constant εᵣ, it has a resonant length shortened as expressed in Equation 1 below:

$$λ = \frac{{λ}_{0}}{\sqrt{{ɛ}_{r}}} , \qquad Equation 1$$

where λ is the resonant length of the antenna, λ₀ is free space wavelength, and εᵣ is the relative dielectric constant of the dielectric substance.

While the wavelength of the dielectric antenna can be shortened according to including dielectric material which has higher dielectric constant, the bandwidth of the dielectric antenna is narrowed at the same time, thereby restricting its practicability. As a result, dielectric materials having a relative dielectric constant of 5 to 10 have been generally used.

Such a dielectric antenna can be reduced in size to the extent that it can be adopted for a mobile communication terminal in a frequency bandwidth of 800 MHz, in which a short wavelength is used in mobile communication, wireless Local Area Network (LAN), Radio Frequency Identification (RFID), Bluetooth, Global Positioning System (GPS) and so on. However, in a bandwidth of 300 MHz or less having a long wavelength such as in the above-described terrestrial DMB, an antenna length of 5 cm or more is required. This, as a result, makes it impractical to apply the dielectric antenna inside a mobile communication terminal.

Accordingly, the art requires development of a compact antenna that can be installed inside a mobile communication terminal using a signal in a bandwidth of 300 MHz or less.

### SUMMARY OF THE INVENTION

The present invention has been made to solve the foregoing problems of the prior art and it is therefore an object of the present invention to provide a layer-built antenna which adopts a substrate made of a composite containing magnetic material and polymer resin or a high magnetic permeability layer adjacent to a conductive antenna pattern in order to greatly shorten resonant length, thereby enabling size reduction even in a bandwidth of several hundred MHz.

According to an aspect of the invention for realizing the foregoing object, the invention provides a layer-built antenna comprising: antenna structures each including a magnetic dielectric substrate having predetermined relative magnetic permeability and relative dielectric constant and a conductive antenna pattern formed on the magnetic dielectric substrate; and a feeding part formed on surface of the magnetic dielectric substrates of at least one of the antenna structures and electrically connected with the conductive antenna patterns of the antenna structures, wherein the antenna structures are stacked one on another, and the conductive antenna patterns on upper and lower ones of the stacked antenna structures are electrically connected together.

According to a preferred embodiment of the invention, each of the antenna structures further includes a high magnetic permeability layer formed on or underneath the conductive antenna pattern, having a relative magnetic permeability higher than that of the magnetic dielectric layer. Preferably, the relative magnetic permeability of the high magnetic permeability layer is 1.1 times or more of that of the magnetic dielectric substrate. Preferably, the high magnetic permeability layer has a thickness of 5 μm to 100 μm, and may comprise a magnetic oxide containing at least two elements selected from a group consisting of Fe, Ni, Co, Mn, Mg, Ba, Sr and Zn. More preferably, the high magnetic permeability layer comprises ferrite.

According to another embodiment of the invention, the magnetic dielectric substrate preferably has a relative magnetic permeability of 2 to 100 and a relative dielectric constant of 2 to 100, and is preferably made of a composite of magnetic material and polymer resin.

In this case, the magnetic material may comprise a magnetic oxide containing at least two elements selected from a group consisting of Fe, Ni, Co, Mn, Mg, Ba, Sr and Zn. The magnetic material may comprise at least one material selected from a group consisting of ferrite, magnetic metal and amorphous magnetic material. Furthermore, the polymer resin may comprise at least one material selected from a group consisting of epoxies, phenols, nylons and elastomers.

According to other embodiment of the invention, the conductive antenna pattern may comprise at least one element selected from a group consisting of Ni, Cu, Ag, Au and Pd.

The layer-built antenna of the invention may further comprise a cover layer formed on the magnetic dielectric substrate of an uppermost one of the antenna structures, thereby burying the conductive antenna pattern on the uppermost antenna structure, the cover layer having a predetermined relative magnetic permeability and a predetermined relative dielectric constant.

Preferably, the relative magnetic permeability of the cover layer is lower than that of the high magnetic permeability layer, and more preferably, 2 to 100 and the relative dielectric constant of the cover layer is 2 to 100. The cover layer may comprise a composite of magnetic material and polymer resin.

Preferably, the magnetic material comprises a magnetic oxide containing at least two elements selected from a group consisting of Fe, Ni, Co, Mn, Mg, Ba, Sr and Zn. Alternatively, the magnetic material may comprise at least one substance selected from a group consisting of ferrite, magnetic metal and amorphous magnetic material. Furthermore, the polymer resin may comprise at least one selected from a group consisting of epoxies, phenols, nylons and elastomers.

According to another aspect of the invention for realizing the foregoing object, the invention provides a layer-built antenna comprising: antenna structures each including a substrate, a high magnetic permeability layer having a relative magnetic permeability higher than that of the substrate, formed on the substrate, and a conductive antenna pattern formed on or inside the high magnetic permeability layer; and a feeding part formed on surface of the substrate of at least one of the antenna structures and electrically connected with the conductive antenna pattern of the each antenna structure, wherein the antenna structures are stacked one on another, and the conductive antenna patterns on upper and lower ones of the stacked antenna structures are electrically connected together.

According to an embodiment of the invention, the substrate may comprise a non-magnetic dielectric substrate or a magnetic dielectric substrate, wherein the magnetic dielectric substrate has a relative magnetic permeability of 2 to 100 and a dielectric constant of 2 to 100.

Preferably, the high magnetic permeability layer has a relative magnetic permeability 1.1 times or more of that of the substrate and a thickness of 5 to 100 μm. Preferably, the high magnetic permeability layer may comprise a magnetic oxide containing at least two elements selected from a group consisting of Fe, Ni, Co, Mn, Mg, Ba, Sr and Zn. More preferably, the high magnetic permeability layer may comprise ferrite.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a perspective view illustrating a layer-built antenna according to an embodiment of the invention;

FIG. 1b is a side elevation view of the layer-built antenna shown in FIG. 1a;

FIG. 1c is a cross-sectional view of the layer-built antenna shown in FIG. 1a, provided with a cover layer;

FIG. 2a is an exploded perspective view illustrating a layer-built antenna according to another embodiment of the invention;

FIG. 2b is a side elevation view of the layer-built antenna shown in FIG. 2a;

FIG. 2c is a cross-sectional view of the layer-built antenna as shown in FIG. 2a, provided with a cover layer;

FIGS. 3a to 3d are cross sectional views illustrating layer-built antennas according to further another embodiments of the invention;

FIG. 4 is a cross-sectional view illustrating antenna structures as shown in FIG. 3c, stacked into a two-layer structure; and

FIGS. 5a to 5b, 6a to 6b and 7a to 7b are graphs illustrating resonant frequencies of layer-built antennas according to various embodiments of the invention.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. In the drawings, the shape and dimensions of components may be exaggerated for clarity. Like numbers refer to the same or like components throughout.

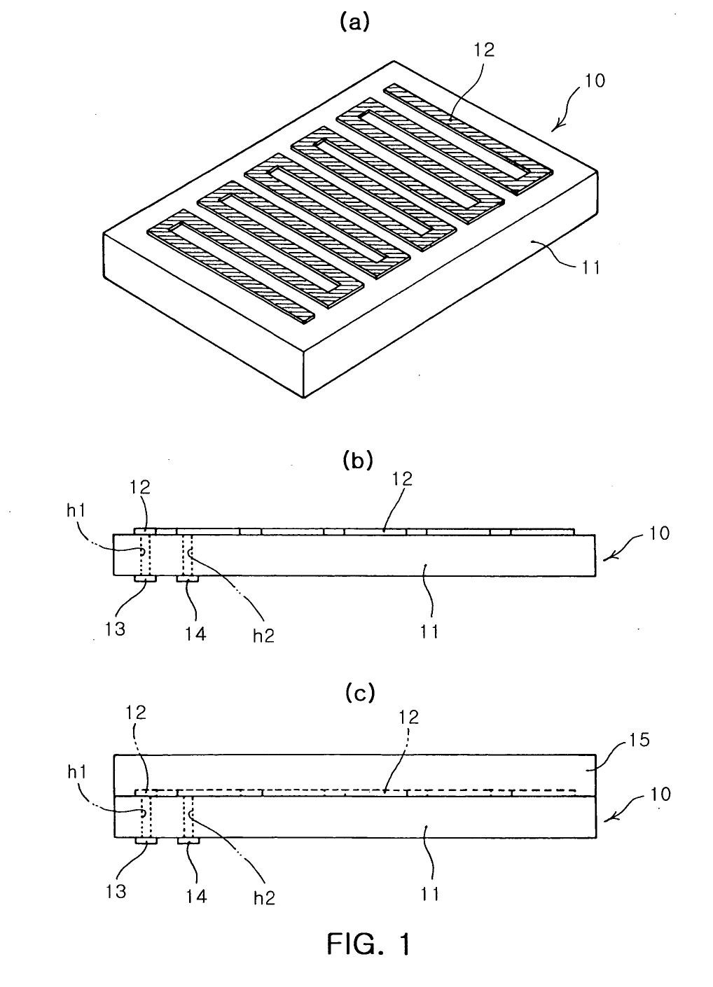

FIG. 1a is a perspective view illustrating a layer-built antenna according to an embodiment of the invention. As shown in FIG. 1a, the layer-built antenna of this embodiment has an antenna structure 10 including a magnetic dielectric substrate 11 and a conductive antenna pattern 12 formed on the magnetic dielectric substrate 11. The magnetic dielectric substrate 11 has predetermined values of relative magnetic permeability and relative dielectric constant.

In addition, the antenna structure 10 also includes a feeding part electrically connected with the conductive antenna pattern 12, for supplying electric signals to the antenna pattern 12. The feeding part is designated with the reference sign 13 in the side elevation view of FIG. 1b. As shown in FIG. 1b, the feeding part 13 is formed on the underside of the magnetic dielectric material substrate 11, and can be electrically connected with the conductive antenna pattern 12 by a conductive via h1. While the feeding part has been illustrated in FIG. 1b as formed on the underside of the magnetic dielectric substrate, the feeding part may be formed in various positions according to various embodiments.

The layer-built antenna of this embodiment may further include a ground part 14 for grounding the antenna pattern 12 similar to the feeding part 13. The ground part 14 is electrically connected with the conductive antenna pattern 12, and can be formed on the outside surface of the magnetic dielectric substrate 11. Like the feeding part 13, the ground part 14 is formed on the underside of the magnetic dielectric substrate 11 and electrically connected with the conductive antenna pattern 12 by a conductive via h2. However, the ground part 14 of this embodiment can be formed into various structures.

The magnetic dielectric substrate 11 has suitable values of relative magnetic permeability and relative dielectric constant in order to shorten the resonant length of an antenna. Preferably, the magnetic dielectric substrate 11 has a relative magnetic permeability of about 2 to 100 and a relative dielectric constant of 2 to 100. In order to obtain such properties, the magnetic dielectric substrate 11 preferably adopts a composite of magnetic material and polymer resin.

In this case, the magnetic material may be a magnetic oxide containing at least two elements selected from the group consisting of Fe, Ni, Co, Mn, Mg, Ba, Sr and Zn. Alternatively, the magnetic material may be at least one material selected from the group ferrite, magnetic metal and amorphous magnetic material. The polymer resin may be at least one selected from the group consisting of epoxies, phenols, nylons and elastometers.

As in the present invention, by using magnetic material for a magnetic dielectric substrate, it is possible to shorten the resonant length based upon the magnetic permeability and dielectric constant of the magnetic material as expressed in Equation 2 below:

$$λ = \frac{{λ}_{0}}{\sqrt{{ɛ}_{r} \times {μ}_{r}}} , \qquad Equation 2$$

where λ is the resonant length of an antenna, λ₀ is a wavelength in a free space, εᵣ is the relative magnetic permeability of a magnetic dielectric substrate, and μᵣ is the relative magnetic permeability constant of a magnetic dielectric substrate.

As in Equation 2 above, with use of a magnetic dielectric substrate made of a material having predetermined values of magnetic permeability and dielectric constant, it is possible to shorten the resonant length than that of a conventional magnetic dielectric substrate having a high magnetic permeability (relative magnetic permeability of 1). This as result can further reduce the size of an antenna for receiving a VHF signal having a relatively long wavelength.

For example, while a magnetic dielectric substrate of glass ceramics generally used in a mobile communication terminal antenna has a relative magnetic permeability of about 6, a magnetic dielectric substrate of ferrite-polymer composite has a relative magnetic permeability of about 2 to 10 and a relative dielectric constant of about 4 to 20. So, the magnetic dielectric substrate of ferrite-polymer composite can have a resonant length shorter than that of the conventional glass ceramics magnetic dielectric substrate, thereby enabling size reduction of an antenna.

Further, the invention is aimed to increase magnetic permeability to shorten wavelength while maintaining relative magnetic permeability in a range similar to that of the conventional dielectric antenna. This as a result can overcome prior art problem that available bandwidth for an antenna is narrowed according to increase in relative dielectric constant.

Furthermore, this invention enables fabrication of a magnetic dielectric substrate through the addition of magnetic particles into polymer resin, which enables fabrication of the magnetic dielectric substrate at a relatively lower forming temperature via molding or rolling. This can also impart flexibility to the magnetic dielectric substrate.

In addition, the conductive antenna pattern 12 can be made of at least one element selected from the group consisting of Ni, Cu, Ag, Au and Pd. The conductive antenna pattern 12 may be formed by various techniques well-known in the art. The conductive antenna pattern 12 may be produced, for example, by forming a plating seed layer pattern on the magnetic dielectric substrate 11 via photo-lithography and then electrically plating the plating seed layer pattern; by forming a antenna pattern screen on the magnetic dielectric substrate 11 and then printing conductive paste thereon by using the screen as a printing mask; or by using a metal cladding layer.

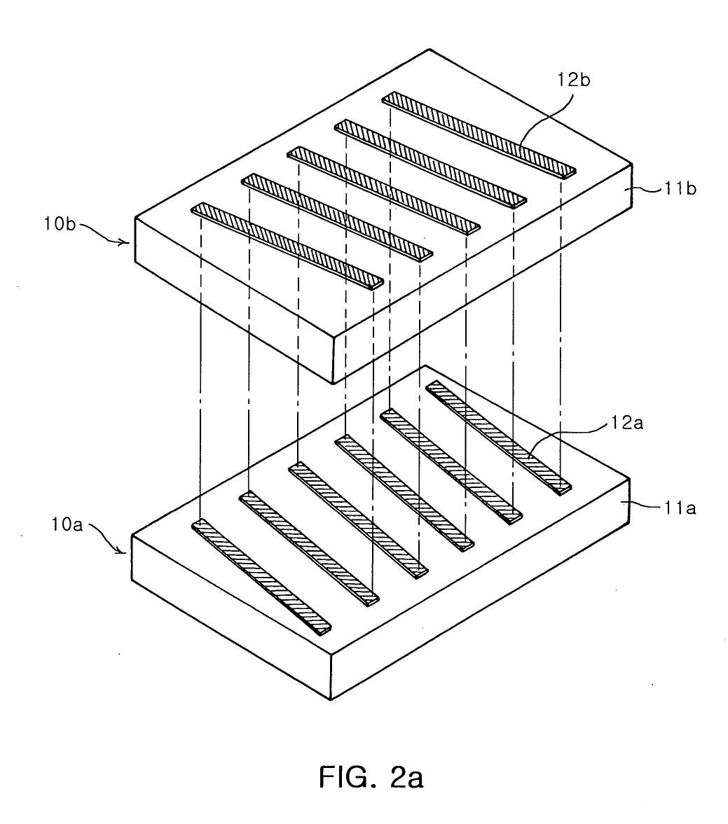

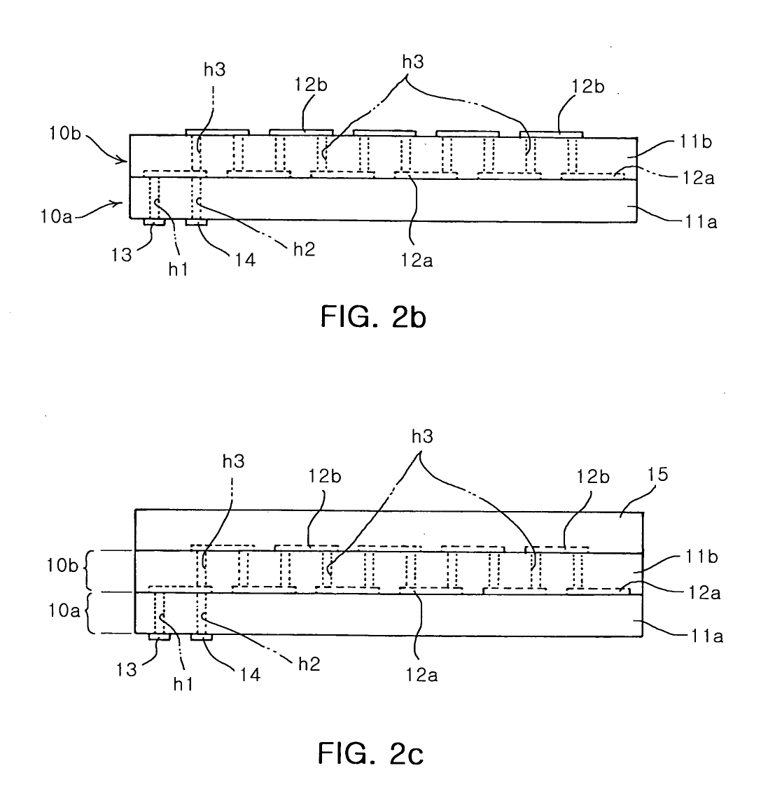

While a planar conductive antenna line shaped as a meander line is illustrated in FIG. 1b, various conductive antenna lines can be adopted. For example, the conductive antenna line may adopt a patched line, a spiral line, a helical line and so on. In this case, a conductive antenna line having a three dimensional structure such as a spiral line and a helical line can be embodied by stacking a plurality of antenna structures 10 one atop another and electrically connecting conductive antenna lines of the antenna structures 10 by conductive vias. Such a structure will be described with reference to FIG. 2.

FIG. 1c is a cross-sectional view of the layer-built antenna shown in FIG. 1a, provided with a cover layer. As shown in FIG. 1c, the layer-built antenna of the invention may further include a cover layer 15 formed on the magnetic dielectric substrate 11 of the antenna structure 10 to bury the conductive antenna pattern 12 on the antenna structure 10. The cover layer 15 has predetermined values of relative magnetic permeability and relative dielectric constant.

The cover layer 15 is formed on the magnetic dielectric substrate 11 to conceal the conductive antenna pattern 12. The cover layer 15 is formed to have predetermined relative magnetic permeability and relative dielectric constant as the above-mentioned magnetic dielectric substrate 11. Therefore, the cover layer 15 functions to protect the conductive antenna pattern 12 while shortening resonant length.

The cover layer 15 can be produced from the same material and in the same process as the above-mentioned magnetic dielectric substrate 11. Accordingly, the detailed description on the cover layer 15 will be substituted by the above explanation on the magnetic dielectric substrate 11.

FIG. 2a is an exploded perspective view illustrating a layer-built antenna according to another embodiment of the invention. As shown in FIG. 2a, the layer-built antenna of this embodiment is of a stacked structure including a first antenna structure 10a having a first magnetic dielectric substrate 11a and a first conductive antenna pattern 12a formed on the first magnetic dielectric substrate 11a; and a second antenna structure 10b having a second magnetic dielectric substrate 11b and a second conductive antenna pattern 12b formed on the second magnetic dielectric substrate 11b. FIG. 2b is a side elevation view of the layer-built antenna shown in FIG. 2a. As shown in FIG. 2b, the first and second conductive antenna patterns 12a and 12b are electrically connected by conductive vias h1 and h2 formed in the second magnetic dielectric substrate 11b, thereby forming a helical antenna structure. Like this, in case that a conductive antenna line of a three-dimensional structure is adopted, the antenna structures 10a and 10b are stacked on each other and the conductive antenna lines 12a and 12b of the upper and lower antenna structures 10a and 10b are electrically connected by the vias h1 and h2, thereby producing an antenna having a three-dimensional antenna structure.

As shown in FIG. 2b, the layer-built antenna of this embodiment further includes a feeding part 13 connected with the first conductive antenna pattern 12a of the first antenna structure 10a to feed electric signals to the first conductive antenna patterns 12a. The feeding part 13 is formed on the underside of the first magnetic dielectric substrate 11a, and electrically connected with the first conductive antenna pattern 12a by the conductive via h1. While the feeding part 13 is illustrated as formed on the underside of the first magnetic dielectric substrate 11a in FIG. 2b, the feeding part 13 may be formed in various portions such as on upper and lateral areas of the first magnetic dielectric substrate 11a and upper and lateral areas of the second magnetic dielectric substrate 11b.

Furthermore, like the feeding part 13, a ground part 14 may be formed on the underside of the first magnetic dielectric substrate 11a and electrically connected with the first conductive antenna pattern 12a by the conductive via h2. However, the ground part 14 may be embodied in various forms.

FIG. 2c is a cross-sectional view of the layer-built antenna as shown in FIG. 2a, provided with a cover layer. As shown in FIG. 2c, a cover layer 15 is formed on the second antenna structure 10b, thereby burying the second conductive antenna pattern 12b. In the layer-built antenna of this embodiment as shown in FIG. 2 where the antenna structures 10a and 10b are stacked on each other, the cover layer 15 is formed on the upper antenna structure 10b since the conductive antenna line 12a of the lower antenna structure 10a is buried by the magnetic dielectric substrate 11b of the upper antenna structure 10b.

This embodiment illustrated with reference to FIG. 2 shows a structural difference from that as above-described and shown in FIG. 1, but shares the sameness in the substance and fabrication method of the magnetic dielectric substrate, the conductive antenna line and the cover layer of the antenna. Herein, detailed description on the same things will be omitted.

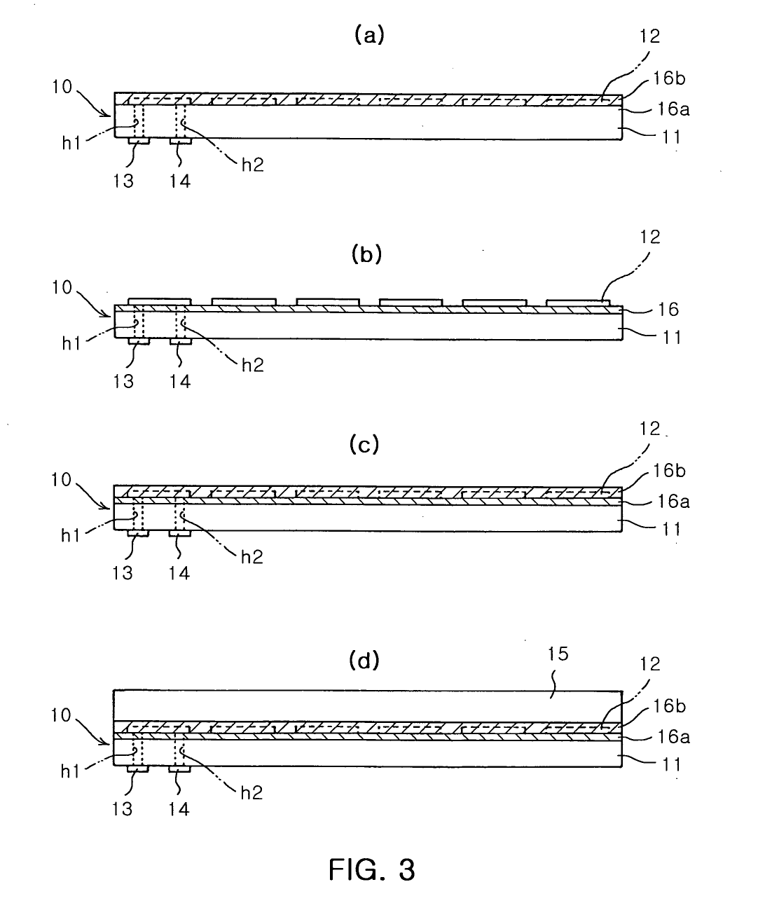

FIGS. 3a to 3d are cross sectional views illustrating layer-built antennas according to further another embodiments of the invention.

As shown in FIG. 3a, an exemplary antenna of the invention includes an antenna structure 10 including a substrate 11, a conductive antenna pattern 12 formed on the substrate 11 and a high magnetic permeability layer 16 formed on the antenna pattern 12 covering the same; and a feeding part 13 electrically connected with the conductive antenna pattern 12, in which the magnetic permeability of the high magnetic permeability layer 16 is higher than that of the substrate 11.

As shown in FIG. 3b, another exemplary antenna of the invention includes an antenna structure 10 including a substrate 11, a high magnetic permeability layer 16 having a magnetic permeability higher than that of the substrate 11, formed on the substrate 11, and a conductive antenna pattern 12; and a feeding part 13 electrically connected with the conductive antenna pattern 12.

Furthermore, as shown in FIG. 3c, further another exemplary antenna of the invention includes an antenna structure 10 including a substrate 11, a first high magnetic permeability layer 16a formed on the substrate 11 and having a magnetic permeability higher than that of the substrate 11, a conductive antenna pattern 12 having a magnetic permeability higher than that of the substrate 11, formed on the high magnetic permeability layer 16 and a second high magnetic permeability layer 16b formed on the antenna pattern 12 to cover the same; and a feeding part 13 electrically connected with the conductive antenna pattern 12.

In addition, as shown in FIG. 3d, a cover layer 15 may be formed on the top of an antenna structure 10. While FIG. 3d illustrates an exemplary cover layer 15 formed on the antenna structure 10 as shown in FIG. 3c, the cover layer 15 may be also formed on those antenna structures 10 as shown in FIGS. 3a and 3b.

As described above, these embodiments as shown in FIGS. 3a to 3c have technical features in that the high magnetic permeability layer 16; 16a, 16b which has higher magnetic permeability than the conductive antenna pattern 12 is formed on/underneath the conductive antenna pattern 12. The embodiments of the invention as shown in FIGS. 1 and 2 adopt a substrate having a uniform magnetic permeability in order to shorten the resonant length. Such a structure has to secure a substrate thickness of a predetermined dimension or more in order to positively shorten the resonant length. On the other hand, with the embodiments as shown in FIGS. 3a to 3d, the high magnetic permeability layer 16; 16a, 16b having a relatively higher magnetic permeability is arranged adjacent to the conductive antenna pattern 12 where electromagnetic induction is concentrated. Such a structure further reduces the substrate thickness over the embodiments shown in FIGS. 1 and 2, thereby facilitating size reduction. Furthermore, since the high magnetic permeability layer 16; 16a, 16b has a larger demagnetization coefficient owing to its film-like configuration, they can further reduce the resonant length compared to the magnetic permeability substrate.

In order to obtain such effects, the high magnetic permeability layer 16; 16a, 16b preferably has a magnetic permeability 1.1 times or more of the relative magnetic permeability, in a film-like configuration with a thickness of 5 μm to 100 μM. At a thickness of the high magnetic permeability layer 16; 16a, 16b less than 5 μm, reduction in the resonant length is hardly expectable. On the other hand, at a thickness exceeding 100 μm high permeability may cause another problem of increase in electromagnetic wave absorption.

Furthermore, the high magnetic permeability layer is preferably made of magnetic oxide containing at least two elements selected from the group consisting of Fe, Ni, Co, Mn, Mg, Ba, Sr and Zn, and more preferably of ferrite.

In the embodiments as shown in FIGS. 3a to 3c, the substrate 11 may adopt a typical dielectric substrate without magnetism (i.e., having a relative magnetic permeability of 1) or a magnetic dielectric substrate as illustrated with reference to FIGS. 2a to 3d. However, explanations on the conductive antenna pattern 12, the feeding part 13, the ground part 14 and the cover layer 15 will be substituted by those given with reference to FIGS. 2a to 2c.

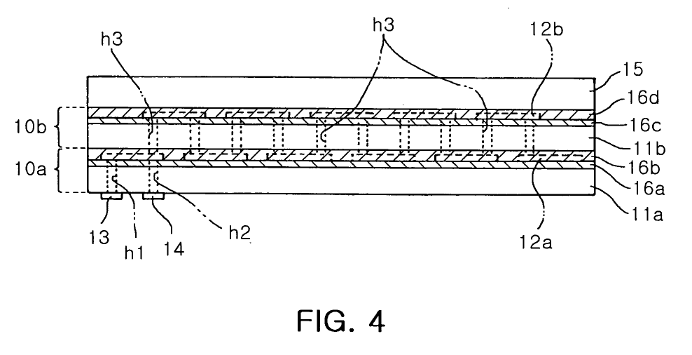

FIG. 4 is a cross-sectional view illustrating antenna structures as shown in FIG. 3c, stacked into a two-layer structure. With reference to FIG. 4, two antenna structures 10a and 10b as shown in FIG. 3c are stacked on each other and an antenna pattern 12a of the antenna structure 10a is electrically connected with an antenna pattern 12b of the antenna structure 10b by a conductive via (not shown), whereby a three-dimensional antenna pattern is realized in the form of for example a helical or spiral structure. While the antenna structures 10a and 10b of this embodiment shown in FIG. 4 each adopt the antenna structure shown in FIG. 3c, they may adopt any antenna structure shown in FIG. 3a or 3b. Furthermore, a cover layer 15 is formed on the top of the uppermost antenna structure 10b. While this embodiment has illustrated the two antenna structures stacked on each other, it will be apparent to those skilled in the art in light of this embodiment that a plurality of antenna structures may be stacked together to produce various forms of stacked or layer-built antennas.

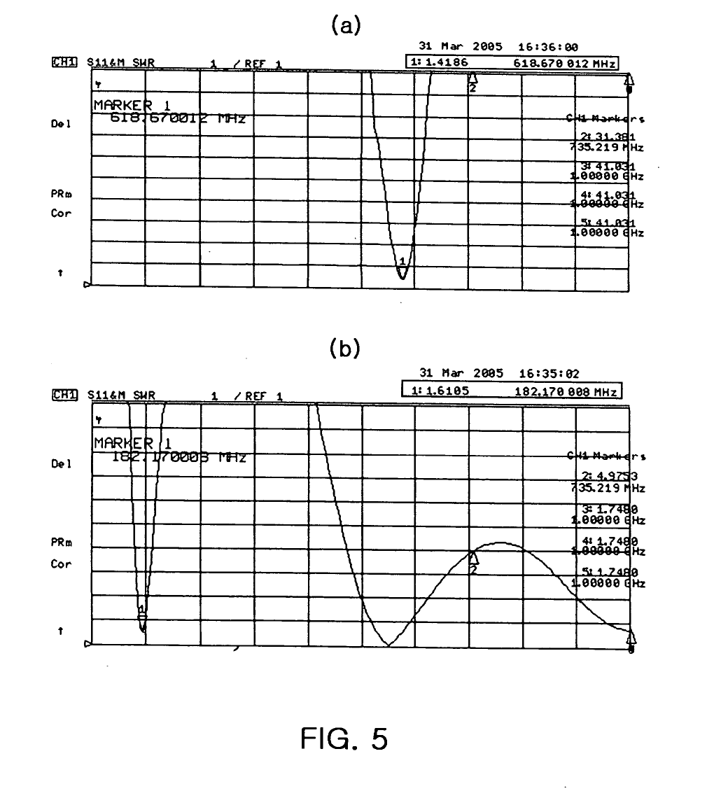

FIGS. 5 to 7 are graphs illustrating resonant frequencies of layer-built antennas according to various embodiments of the invention.

FIG. 5 is graphs for comparing the resonant frequency of an antenna of the invention with that of a conventional antenna. Conductive antenna patterns having a meander line structure of 1 mm width and 0.5 mm interval were formed on an FR4 substrate and a magnetic dielectric substrate of the invention each having dimensions of 50 mm×12 mm×2 mm. The FR4 substrate used as a dielectric substrate in the conventional antenna had a relative dielectric constant of 4.4, and owing to its demagnetism, a relative magnetic permeability of 1. The magnetic dielectric substrate had a relative dielectric constant of about 5.5 and a relative magnetic permeability of about 7.

As shown in FIG. 5(a), the antenna adopting the conventional FR4 substrate had a resonant frequency of 619 MHz. On the contrary, the antenna adopting the magnetic dielectric substrate of the invention with the same dimensions had a resonant frequency of 182 MHz as shown in FIG. 5(b). That is, the antenna adopting the magnetic dielectric substrate of the invention showed a wavelength reduction of about 70.6% from the conventional antenna of the same size.

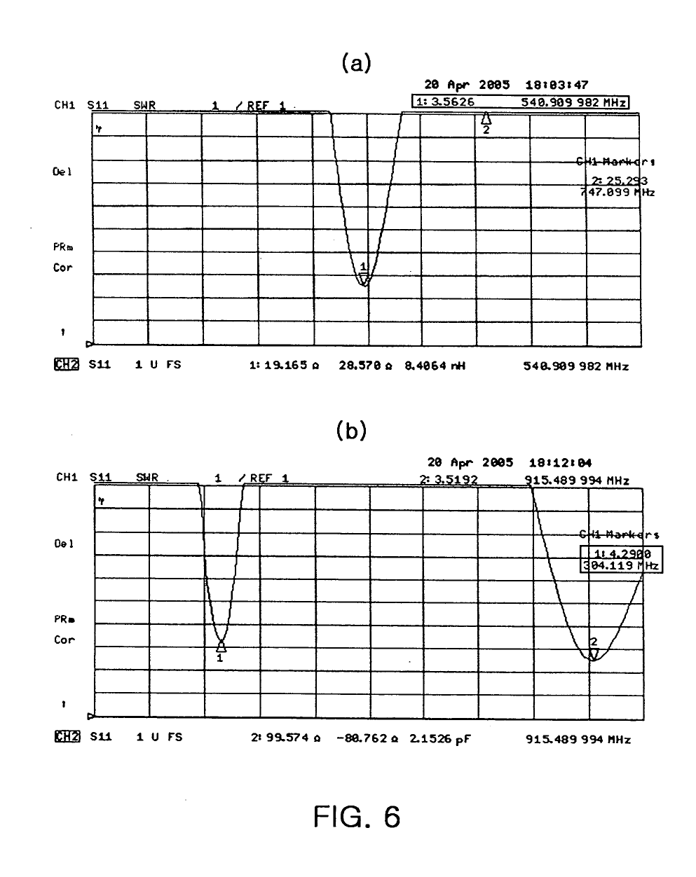

FIG. 6 is graphs for comparing the resonant frequency of an antenna of the invention with that of a conventional antenna. The conventional antenna had a conductive antenna pattern formed on an RF4 substrate, in a meander line structure of 0.2 mm width and 0.5 mm interval. The antenna of the invention included a substrate and a conductive antenna pattern formed on the substrate, both of which had the same specification as those of the conventional substrate, and further included a high dielectric constant layer formed between the substrate and the conductive antenna pattern (see FIG. 3b). The FR4 substrate had a relative dielectric constant of about 4.4 and a relative magnetic permeability of 1, and the high magnetic permeability layer had a relative dielectric constant of about 15 and a relative magnetic permeability of about 50.

As shown in FIG. 6(a), the conventional antenna adopting the FR4 substrate showed a resonant frequency of 540 MHz. On the contrary, the antenna adopting the high magnetic permeability layer of the invention showed a resonant frequency of 304 MHz as shown in FIG. 6(b). That is, the antenna adopting the high magnetic dielectric layer of the invention showed a wavelength reduction of about 43.76% from the conventional antenna of the same size.

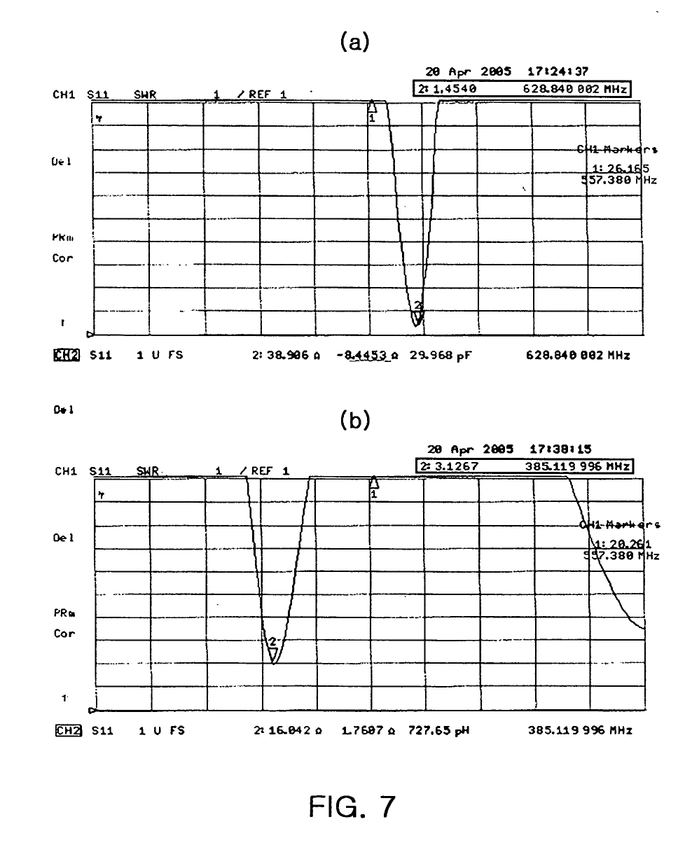

FIG. 7 is graphs for comparing the resonant frequency of an antenna of the invention with that of a conventional antenna. The conventional antenna had a conductive antenna pattern formed on an RF4 substrate, in a meander line structure of 0.3 mm width and 0.5 mm interval. The antenna of the invention included a substrate and a conductive antenna pattern formed on the substrate, both of which had the same specification as those of the conventional substrate, and further included a high dielectric constant layer formed between the substrate and the conductive antenna pattern. The FR4 substrate had a relative dielectric constant of about 4.4 and a relative magnetic permeability of 1 as illustrated with reference to FIGS. 5 and 6, and the high magnetic permeability layer had a relative dielectric constant of about 15 and a relative magnetic permeability of about 50 as illustrated with reference to FIG. 6.

As shown in FIG. 7(a), the conventional antenna adopting the FR4 substrate showed a resonant frequency of 620 MHz. On the contrary, the antenna adopting the high magnetic permeability layer of the invention showed a resonant frequency of 385 MHz as shown in FIG. 7(b). That is, the antenna adopting the high magnetic dielectric layer of the invention showed a wavelength reduction of about 38.79% from the conventional antenna of the same size.

The above-mentioned experiments showing the results of FIGS. 6 and 7 were carried out by using the antennas in which the high magnetic permeability layer was formed only underneath the conductive antenna pattern. As a result, this shows a wavelength reduction larger than an antenna in which the high magnetic permeability layer is also formed on the top of the conductive antenna pattern (see FIG. 3c).

As described hereinbefore, the present invention proposes to adopt a substrate made of a composite containing magnetic material and polymer resin or a high magnetic permeability layer installed adjacent to a conductive antenna pattern in order to greatly reduce resonant length, whereby antenna length can be shortened even in a bandwidth of several hundred MHz.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention.

1. A layer-built antenna comprising:
antenna structures each including a magnetic dielectric substrate having predetermined relative magnetic permeability and relative dielectric constant and a conductive antenna pattern formed on the magnetic dielectric substrate; and
a feeding part formed on surface of the magnetic dielectric substrates of at least one of the antenna structures and electrically connected with the conductive antenna patterns of the antenna structures,
wherein the antenna structures are stacked one on another, and the conductive antenna patterns on upper and lower ones of the stacked antenna structures are electrically connected together.

2. The layer-built antenna according to claim 1, wherein each of the antenna structures further includes a high magnetic permeability layer formed on or underneath the conductive antenna pattern, having a relative magnetic permeability higher than that of the magnetic dielectric substrate.

3. The layer-built antenna according to claim 2, wherein the relative magnetic permeability of the high magnetic permeability layer is 1.1 times or more of that of the magnetic dielectric substrate.

4. The layer-built antenna according to claim 2, wherein the high magnetic permeability layer has a thickness of 5 μm to 100 μm.

5. The layer-built antenna according to claim 2, wherein the high magnetic permeability layer comprises a magnetic oxide containing at least two elements selected from a group consisting of Fe, Ni, Co, Mn, Mg, Ba, Sr and Zn.

6. The layer-built antenna according to claim 2, wherein the high magnetic permeability layer comprises ferrite.

7. The layer-built antenna according to claim 1, wherein the magnetic dielectric substrate has a relative magnetic permeability of 2 to 100 and a relative dielectric constant of 2 to 100.

8. The layer-built antenna according to claim 1, wherein the magnetic dielectric substrate comprises a composite of magnetic material and polymer resin.

9. The layer-built antenna according to claim 8, wherein the magnetic material comprises a magnetic oxide containing at least two elements selected from a group consisting of Fe, Ni, Co, Mn, Mg, Ba, Sr and Zn.

10. The layer-built antenna according to claim 8, wherein the magnetic material comprises at least one material selected from a group consisting of ferrite, magnetic metal and amorphous magnetic material.

11. The layer-built antenna according to claim 8, wherein the polymer resin comprises at least one material selected from a group consisting of epoxies, phenols, nylons and elastomers.

12. The layer-built antenna according to claim 1, wherein the conductive antenna pattern comprises at least one element selected from a group consisting of Ni, Cu, Ag, Au and Pd.

13. The layer-built antenna according to claim 1, further comprising a cover layer formed on the magnetic dielectric substrate of an uppermost one of the antenna structures, thereby burying the conductive antenna pattern on the uppermost antenna structure, the cover layer having a predetermined relative magnetic permeability and a predetermined relative dielectric constant.

14. The layer-built antenna according to claim 13, wherein the relative magnetic permeability of the cover layer is lower than that of the high magnetic permeability layer.

15. The layer-built antenna according to claim 13, wherein the relative magnetic permeability of the cover layer is 2 to 100 and the relative dielectric constant of the cover layer is 2 to 100.

16. The layer-built antenna according to claim 13, wherein the cover layer comprises a composite of magnetic material and polymer resin.

17. The layer-built antenna according to claim 16, wherein the magnetic material comprises a magnetic oxide containing at least two elements selected from a group consisting of Fe, Ni, Co, Mn, Mg, Ba, Sr and Zn.

18. The layer-built antenna according to claim 16, wherein the magnetic material comprises at least one substance selected from a group consisting of ferrite, magnetic metal and amorphous magnetic material.

19. The layer-built antenna according to claim 16, wherein the polymer resin comprises at least one selected from a group consisting of epoxies, phenols, nylons and elastomers.

20. A layer-built antenna comprising:
antenna structures each including a substrate, a high magnetic permeability layer having a relative magnetic permeability higher than that of the substrate, formed on the substrate, and a conductive antenna pattern formed on or inside the high magnetic permeability layer; and
a feeding part formed on surface of the substrate of at least on of the antenna structures and electrically connected with the conductive antenna pattern of the each antenna structure,
wherein the antenna structures are stacked one on another, and the conductive antenna patterns on upper and lower ones of the stacked antenna structures are electrically connected together.

21. The layer-built antenna according to claim 20, wherein the substrate comprises a non-magnetic dielectric substrate or a magnetic dielectric substrate, wherein the magnetic dielectric substrate has a relative magnetic permeability of 2 to 100 and a relative dielectric constant of 2 to 100.

22. The layer-built antenna according to claim 20, wherein the high magnetic permeability layer has a relative magnetic permeability 1.1 times or more of that of the substrate.

23. The layer-built antenna according to claim 20, wherein the high magnetic permeability layer has a thickness of 5 to 100 μm.

24. The layer-built antenna according to claim 20, wherein the high magnetic permeability layer comprises a magnetic oxide containing at least two elements selected from a group consisting of Fe, Ni, Co, Mn, Mg, Ba, Sr and Zn.

25. The layer-built antenna according to claim 20, wherein the high magnetic permeability layer comprises ferrite.
